(19) United States
(12) Patent Application Publication
(10) Pub. No.: US 2010/0051306 A1
(43) Pub. Date: Mar. 4, 2010

(54) HIGH VOLTAGE BUSHING

(75) Inventors: Christer Törnkvist, Stromsholm (SE); Ola Widlund, Stockholm (SE)

Correspondence Address: VENABLE LLP, P.O. BOX 34385, WASHINGTON, DC, 20043-9998, US

(73) Assignee: ABB Research LTd, Zurich (CH)

(21) Appl. No.: 12/447,960

(22) PCT Filed: Oct. 31, 2007
(86) PCT No.: PCT/EP2007/061749

§ 371 Date: Apr. 30, 2009

(30) Foreign Application Priority Data
Oct. 31, 2006 (EP) 06123222.9

(51) Int. Cl. H01B 17/54

(52) U.S. Cl. 174/15.3

(57) ABSTRACT

A high voltage bushing for transferring AC or DC high voltage and current. The bushing includes an electrically connectable electrical conductor, an insulator housing enclosing the conductor, and a space filled with an electrically insulating gas in between said insulator housing and said conductor. The electrical conductor is coated with a surface layer of a material having a thermal emissivity substantially larger than a thermal emissivity of the conductor.

### FIELD OF THE INVENTION

The present invention relates to the field of electrical power distribution systems and in particular to cooling of high voltage bushings in such power distribution systems.

### BACKGROUND OF THE INVENTION

Electrical equipment and devices, and in particular high voltage equipment in an electrical power distribution system, have high heat dissipation and therefore require adequate cooling. For example, a conventional HVDC (High-Voltage Direct Current) converter valve may be air insulated and water-cooled. A cooling system is conventionally provided comprising for example cooling water distribution pipes that are shaped to fulfil certain requirements. Another example of an external cooling system is the use of fans.

However, there are also electrical devices within a power distribution system that are not cooled by any external cooling system. Those devices, lacking an external cooling system, are then instead just self-cooled, i.e. natural convective air-cooling or cooling by emission of heat radiation or a combination of these. One example of such a self-cooled device is a wall bushing.

A high voltage bushing is a device used to carry current at high potential through a grounded barrier, for example a wall, or an enclosure of an electrical apparatus such as a transformer tank. The bushing keeps current from passing into the grounded barrier by virtue of its insulating properties.

Bushings can be designed in several different ways. One such type of bushing is a condenser bushing comprising a conductor, which is at least partly enclosed by a condenser core, and an outer insulator housing comprising a body of dielectric material such as porcelain or polymeric material. The space between the outer insulator housing and the conductor with the enclosed condenser core is filled with insulation oil or gas. The condenser core comprises layers of metal enclosed on both sides by insulating material. The condenser core takes care of the voltage grading in the space close to where the bushing is passing through a wall of a building or the wall of a container e.g. a transformer tank.

Another type of bushing comprises a conductor, a reflector and an outer insulator housing comprising a body of dielectric material such as porcelain or polymeric material. The reflector has the same function as the condenser core. The space between the conductor, the reflector and the outer insulator housing is normally filled with a gas e.g. sulphur hexafluoride or mixtures of sulphur hexafluoride and other gases. This is a typical wall bushing. Typical voltage levels within electrical power distribution systems range from 70 kV AC or DC up to about 500 kV AC or DC. However, the voltage levels increases constantly and may, for DC, amount to as much as 800 kV DC and presumably even higher voltage levels in the future. Also, current levels may be up to 4000-5000 A or even higher. Naturally, such high voltages and current levels result in still higher heat dissipation.

Freeman et. al., in U.S. Pat. No. 5,466,891, disclose a high voltage bushing where a floating shield, i.e. a shield which is electrically connected neither to ground nor to the high potential of the bushing, is suspended within the bushing housing by a supporting insulator placed in the low electrical stress region of the bushing. Freeman et. al., in their invention and in the background art disclose high voltage bushings of the kind that form prior art with respect to the present invention and U.S. Pat. No. 5,466,891 is considered to form the closest prior art. The bushings disclosed in U.S. Pat. No. 5,466,891 transfer AC or DC high voltage and current, comprises an electrically connectable electrical conductor, comprises an insulator housing enclosing the conductor, and further comprises a space filled with an electrically insulating gas in between the insulator housing and the conductor.

If the cooling is not sufficient the dissipated heat will increase the temperature of the conductor of the bushing. The conductor of the bushing is normally made of a metal, usually aluminium or copper. Since a wall bushing normally is mounted with an angle with respect to the wall, so that rain and moisture will drip off, e.g. in order to avoid tracking failure, the outer top end of the bushing is at a higher level compared to the inner down end. This means that when there is mainly convective cooling of the conductor there is a temperature difference between the outer top end and the inner down end of the bushing since the warmer gas tends to flow upwards and the cooler gas tends to flow downwards. This temperature difference causes thermal stresses to the outer insulator housing, in the longitudinal direction of the bushing. Also in the circumferential direction of the bushing there are temperature differences along the inner surface of the outer insulator housing since there are circumferential variations in the flow of the gas, as viewed in a plane perpendicular to the conductor. This will cause circumferential thermal stresses to the outer insulator housing of the bushing. On the other hand if the cooling is carried out through radiation emission there would not be such differences as mentioned above since emissive cooling is isotropic i.e. it is the same in all directions in a plane perpendicular to the conductor. Also there would not be any temperature differences in the longitudinal direction of the bushing since the cooling is not dependent on gas flow from a warmer part to a cooler and opposite. Increasing the emissive cooling will hence alleviate the thermal stresses of the outer insulator housing and enables operation with higher voltages and currents.

In view of the above, it would be desirable to enable improved emissive cooling of high voltage bushings.

### SUMMARY OF THE INVENTION

It is an object of the present invention to provide an improved emissive cooling of bushings within an electrical power distribution system. In particular, it is an object of the invention to provide an improved emissive cooling of bushings that is adequate also for very high voltages and currents, such as voltages of between 70 and 500 kV and currents of up to 5000 A, thereby overcoming or at least alleviating the above-mentioned drawbacks of the prior art.

It is yet another object of the present invention to provide cooling means for cooling bushings without increasing the size of the constituent parts when increasing the dissipated power in the bushing by increasing the current and voltage levels.

These objects, among others, are achieved by a high voltage bushing as claimed in claim 1.

In accordance with the invention the electrical conductor is coated with a surface layer of a material having a thermal emissivity substantially larger than the thermal emissivity of the conductor.

The inventive way of cooling bushings by utilizing a surface layer on the conductor, which has a substantially larger thermal emissivity than the conductor itself, enables a cost-efficient and reliable improved cooling. By means of the invention the design of a bushing is significantly simplified, as the temperature differences in the outer insulator housing is kept under control. In particular, the size of the bushings does not increase although utilizing higher currents and voltages. Further, adequate cooling of bushings is accomplished even for high currents and high voltage levels, for example ranging up to 500 kV and even further up to very high voltage levels.

In accordance with an embodiment of the invention, the electrical conductor of the high voltage bushing is coated with a surface layer which has a thermal emissivity which is preferably at least 3 times larger than the thermal emissivity of the conductor, more preferably at least 5 times larger than the thermal emissivity of the conductor and most preferably at least 7 times larger than the thermal emissivity of the conductor. An advantage of the invention is that such a layer could be made thin and will substantially increase the thermal emissivity of the conductor while still not alter any dimensional demands of the bushing. An example of such a conductor is an aluminium conductor where the emissivity of “commercial sheet” material is ca. 0.09. By enhancing the oxidation of the surface an emissivity of ca. 0.3 may be reached. A size and cost-efficient solution is thereby provided.

In accordance with another embodiment of the invention, the electrical conductor made of aluminium is anodized to the surprising effect of substantially increasing the cooling performance of the conductor. The emissivity of the anodized conductor is approximately 0.8. For a bushing conductor made of aluminium this embodiment is advantageous since it is easily facilitated, with commercially available and simple means, and the efficiency of the conductor with respect to cooling is substantially improved.

In accordance with another embodiment of the invention, the electrical conductor is coated with a surface layer substantially comprising an oxide. Examples of such oxides are copper oxide, chromium oxide and nickel oxide. An advantage of such a surface layer is that a very high emissivity can be reached. According to Handbook of Chemistry and Physics, 1971-72, 52^{nd} Edition, Published by the Chemical Rubber Co, the emissivity of, for example, nickel oxide is 0.85-0.96 which is close to 10 times the emissivity of “commercial sheet” aluminium.

In accordance with another embodiment of the invention, the electrical conductor is coated with a surface layer substantially comprising a metal. Examples of such metals are titanium, manganese and erbium. An advantage of such a surface layer is that the layer can be made very thin. According to Handbook of Chemistry and Physics, 1971-72, 52^{nd} Edition, Published by the Chemical Rubber Co the emissivity of, for example, titanium is 0.63 which is 7 times the emissivity of “commercial sheet” aluminium.

In accordance with another embodiment of the invention, the electrical conductor is coated with a surface layer substantially comprising an aluminium oxide. An advantage of aluminium oxide is that it is inherently compatible with aluminium which is very often used as a conductor material. Another advantage is that it is very inert and intoxic.

In accordance with another embodiment of the invention, the electrical conductor is coated with a surface layer substantially comprising of an organic or semi-organic substance. Examples of such substances are acrylic polymer paints and epoxy paints. An advantage with such layer materials is that they are very easy to apply using a brush or with a spraying device. Another advantage is that the layer is inexpensive since both the material and the application method are low cost.

The layer thickness is measured as the difference between the outer surface of the layer, taking into account the mean deviation Rₐ, and the lower surface of the layer, contacting the conductor body, taking into account the mean deviation Rₐ for this surface. Investigations of the layers have shown that the surface fineness according to the definition (see e.g. S. Jacobsson and S. Hogmark, Tribologi, Karleboserien, Liber Utbildning AB, Arlöv 1996, p. 16)

Rₐ=1/L·∫|z(x)| dx

with a lower limit x=0 and an upper limit x=L

Further embodiments are defined in the dependent claims.

Further characteristics, advantages and objects of the invention will become apparent when reading the following detailed description.

### BRIEF DESCRIPTION OF THE DRAWINGS

FIG. 1 is an overall view of a high voltage bushing according to an embodiment of the invention.

FIG. 2 is a schematic cross-sectional view of a conductor unit of the high voltage bushing along the line A-A in FIG. 1.

### DETAILED DESCRIPTION OF PREFERRED EMBODIMENTS

When applicable the same reference numerals are used throughout the description for denoting same or similar parts.

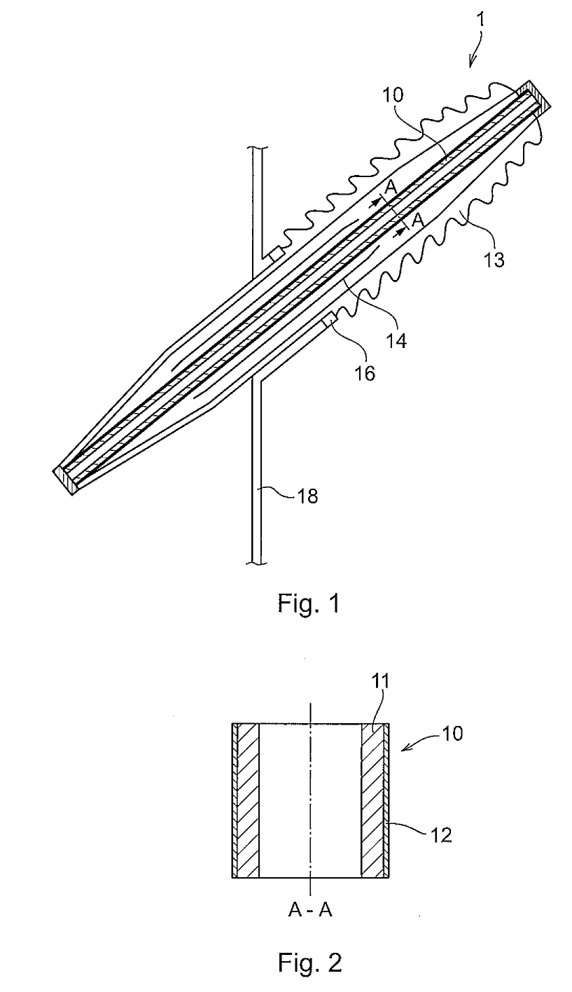

A bushing according to an embodiment of the invention is shown in FIG. 1. The bushing comprises a high voltage conductor unit 10. In FIG. 2, a cross-sectional view of the high voltage conductor unit 10 of the bushing 1 of FIG. 1 is shown. The voltage conductor unit 10 comprises an electrical conductor 11 and an emissive surface layer 12 of a material having a thermal emissivity substantially larger than the thermal emissivity of the conductor 11. The high voltage conductor unit 10 runs through the centre of a hollow bushing insulator 13, which forms a housing around the high voltage conductor unit 10. Typically, for an open air application the insulator housing 13 is made of either porcelain or a polymeric material such as epoxy with the outer side comprising silicone sheds.

In a reflector bushing, a rotationally symmetrical reflector 14 is provided, within the insulator housing 13, for voltage grading. The voltage stress on the bushing and its surrounding structure includes both AC and DC components. AC component voltage grading depends on the insulation material permittivities. DC component voltage grading depends on the temperature dependent resistivities of the insulation materials. A flange 16 is provided to connect the insulator housing 13 of the bushing to ground through a wall 18. Although a reflector bushing is illustrated in the figure, it is realized that the present invention could be utilized in a non-reflector bushing as well.

According to an embodiment of the invention, the electrical conductor 11 is made of aluminium and the surface layer 12 is made of anodized aluminium. The surface layer 12 of anodized aluminium is applied by means of anodization and subsequent sealing of the anodized layer. This layer has a thermal emissivity of approximately 0.8 which is substantially larger than the thermal emissivity of the aluminium conductor itself which is approximately 0.09. The thickness of the layer is in this specific embodiment approximately 20 μm. The thickness can also be less than 20 μm down to approximately 5 μm. It can also be larger than 20 μm up to approximately 40 μm.

In another embodiment of the present invention the high voltage conductor 11 of the bushing is made of aluminium and is provided with a surface layer 12 of pigmented epoxy paint. The epoxy paint was brushed on to the electrical conductor 11. The pigment in this specific embodiment is zink oxide. It is realized that any other suitable pigment making the epoxy paint opaque may be utilized. This layer has a thermal emissivity of approximately 0.8 which is substantially larger than the thermal emissivity of the high voltage conductor itself. The thickness of such a layer is in this specific embodiment approximately 50 μm.

In another embodiment of the invention the high voltage conductor 11 is made of aluminium and is provided with a surface layer 12 of water based acrylic polymer paint. The water based acrylic polymer paint comprises a pigment of cobalt oxide. It is realized that any other suitable pigment making the water based acrylic polymer paint opaque may be utilized. This layer has a thermal emissivity of approximately 0.9 which is substantially larger than the thermal emissivity of the high voltage conductor itself. The thickness of the layer is in this specific embodiment approximately 40 μm.

In another embodiment of the invention the high voltage conductor 11 is made of copper and is provided with a surface layer 12 of titanium. It is realized that any other suitable metal or alloy may be utilized. This layer has a thermal emissivity which is approximately 0.6 which is substantially larger than the thermal emissivity of the high voltage copper conductor which is approximately 0.1. The thickness of the layer is in this specific embodiment approximately 10 μm.

The inventive way of cooling bushings by utilizing a surface layer to increase the thermal emissivity enables a cost-efficient and reliable improved cooling. By means of the invention the design of a bushing will be significantly simplified, as the temperature of the conductor and temperature differences of the insulation housing of the bushing is kept at a lower level. For higher voltages, for example 800 kV DC, a prior art bushing would have to become very large in order to carry for example 4000 A. The inventive cooling of the high voltage bushing gives a lower diameter of the conductor and thereby a reduced size of the whole bushing.

Further, adequate cooling of bushings is accomplished even for high currents and high voltage levels, for example ranging from 500 kV DC up to 800 kV DC and further up to very high voltage levels.

The present invention is applicable, for example, for a valve hall wall bushing and an indoor smoothing reactor bushing.

In the preceding detailed description, the invention is described with reference to specific exemplary embodiments thereof. Various modifications and changes may be made thereto without departing from the scope of the invention as set forth in the claims. The specification and drawings are, accordingly, to be regarded in an illustrative rather than a restrictive sense. Thus, although oxides, organic paints and metals have been described as a preferred material for the surface layer on the high voltage conductor other materials are possible alternatives to that.

1. A high voltage bushing for transferring AC or DC high voltage and current, said bushing comprising:
an electrically connectable electrical conductor,
an insulator housing enclosing said conductor, and
a space filled with an electrically insulating gas in between said insulator housing and said conductor,
wherein said electrical conductor is coated with a surface layer of a material having a thermal emissivity substantially larger than a thermal emissivity of the conductor.

2. The high voltage bushing according to claim 1, wherein said surface layer has a thermal emissivity which is at least 3 times larger than the thermal emissivity of the conductor.

3. The high voltage bushing according to claim 1, wherein said surface layer has a thermal emissivity which is at least 5 times larger than the thermal emissivity of the conductor.

4. The high voltage bushing according to claim 1, wherein said surface layer has a thermal emissivity which is at least 7 times larger than the thermal emissivity of the conductor.

5. The high voltage bushing according to claim 1, wherein said surface layer substantially comprises a metal.

6. The high voltage bushing according to claim 1, wherein said surface layer substantially comprises an oxide.

7. The high voltage bushing according to claim 6, wherein said surface layer substantially comprises an aluminum oxide.

8. The high voltage bushing according to claim 1, wherein said surface layer comprises anodized aluminum.

9. The high voltage bushing according to claim 1, wherein said surface layer substantially comprises an organic or semi-organic substance.
